(19) United States
(12) Patent Application Publication
(10) Pub. No.: US 2015/0106871 A1
(43) Pub. Date: Apr. 16, 2015

(54) SYSTEM AND METHOD FOR CONTROLLING ACCESS TO SECURITY ENGINE OF MOBILE TERMINAL

(71) Applicant: Electronics and Telecommunications Research Institute, Daejeon (KR)

(72) Inventor: Jae Deok LIM, Daejeon (KR)

(73) Assignee: Electronics and Telecommunications Research Institute, Daejeon (KR)

(21) Appl. No.: 14/331,474

(22) Filed: Jul. 15, 2014

(30) Foreign Application Priority Data
Oct. 15, 2013 (KR) 10-2013-0122941
Mar. 28, 2014 (KR) 10-2014-0036815

(51) Int. Cl. G06F 21/44; G06F 21/31

(52) U.S. Cl. CPC G06F 21/44; G06F 21/31
USPC 726/1; 726/16; 726/17

(57) ABSTRACT

Provided is a system for controlling access to a security engine of a mobile terminal including a basic operating system and a security engine in which an app ID and user authentication information are transmitted to the security engine in order to execute a reliable app installed in the basic operating system and use a security function of the security engine, and the security engine performs authentication of whether an app is the reliable app or whether a user executing the reliable app is an owner of the mobile terminal based on the app ID transmitted from the basic operating system and the user authentication information and then permits access to the security engine.

### CROSS-REFERENCE TO RELATED APPLICATIONS

This application claims priority under 35 U.S.C. §119 to Korean Patent Application No. 10-2014-0036815, filed on Mar. 28, 2014, and Korean Patent Application No. 10-2013-0122941, filed on Oct. 15, 2013, the disclosure of which is incorporated herein by reference in its entirety.

### TECHNICAL FIELD

The present invention relates to a system and method for controlling access to a security engine of a mobile terminal, and more particularly, to a system and method for controlling access to a security engine of a mobile terminal that can enhance security of a mobile terminal by registering an identification (ID) of an application (hereinafter referred to as “app”) with a security engine in a basic operating system and when performing access from the basic operating system to the security engine, allowing the access after authenticating an app installed in a mobile terminal and an owner of the mobile terminal.

### BACKGROUND

Mobile terminals tend to be utilized in a task such as a Smart Work in addition to a financial service such as Internet banking and stock trading, because of the convenience such as Internet connectivity and portability.

As a number of services using mobile terminals are provided, malicious codes in personal computers are rapidly spread on mobile terminals, thereby increasing damage such as enterprise information leakage in addition to personal property damage.

Thus mobile operating systems provide patch and upgrade to fix security vulnerability and mobile security applications are provided from separate security enterprises. However, there is a limitation in responding to an intelligent hacking technique.

An existing platform-level security technology may allow an operating system to identify a business app and a personal app by strengthening an access control function in a basic operating system.

Thus through virtualization technology and technology for performing control such that the personal app cannot access data of the business app, the same or the same level operating system is completely divided into different operating areas. One area is used for a personal app, and the other are is used for a business app, thereby controlling sharing of data between the personal app and the business app.

In technology for controlling access to business data through access control in an operating system level, the access control is performed in the operating system level. However, there are malicious codes in addition to a protected space, such that the security vulnerability may be always potential. And, if the security vulnerability is detected, a patch for fixing the vulnerability should be developed.

A structure having the divided operating areas through virtualization technology may separate a personal space from a business space to prevent data leakage from the business area through security vulnerability of the personal area.

However, since the business area has the same security level as the personal area, data may be leaked not by invasion from the personal area but through security vulnerability of the business area.

To fundamentally solve these problems, a structure for isolating an area in which a security function is performed from a basic operating system area has lately attracted considerable attention, and various studies are being conducted on this structure.

### SUMMARY

Accordingly, the present invention provides a system for registering an app ID of the mobile terminal and a system and method for controlling access to a security engine of the mobile terminal, which can enhance security of the mobile terminal by registering an app ID with a security engine by a basic operating system, and when accessing the security engine from the basic operating system, perform the access after authenticating an app installed in the mobile terminal and an owner of the mobile terminal.

In one general aspect, a system for registering an app ID of a mobile terminal, the system includes: a basic operating system perform app authentication through a verification process for a downloaded app and when the authentication is successful, calculate an app ID of the downloaded app and transmit the app ID to the security engine; and a security engine configured to store the app ID calculated in the basic operating system.

The basic operating system may include: an app authentication module configured to perform app authentication through a verification process for the downloaded app; an app storage unit configured to have an app installed therein, the app being authenticated by the app authentication module; and a security engine application programming interface (API) configured to calculate an app ID of the app authenticated by the app authentication module and transmits the app ID to the security engine.

The security engine may include: an access control policy database (DB) configured to store an app ID of a reliable app; and an access control module configured to receive the app ID transmitted from the basic operating system and store the app ID in the access control policy DB.

The basic operating system may verify whether the downloaded app is distributed through a normal route or from a normal app store or whether the downloaded app is falsified to perform the app authentication.

The verification of whether the downloaded app is distributed from the normal app store and the verification of whether the downloaded app is falsified is achieved through an electronic signature using a certificate or through integrity information authentication for the app file.

When the app authentication is failed in the app authentication module, the installation of the downloaded app may be stopped or the downloaded app may be stored as a general app in the app storage.

The calculation of the app ID by the security engine API may be performed using a one-direction hash algorithm.

In another general aspect, a system for controlling access to a security engine of a mobile terminal, the system includes: a basic operating system configured to execute a reliable app installed therein to transmit an app ID and user authentication information to the security engine in order to use a security function of the security engine; and a security engine configured to authenticate whether an app is the reliable app or whether a user executing the reliable app is an owner of the mobile terminal based on the app ID transmitted and the user authentication information from the basic operating system and then permit access to the security engine.

The basic operating system may include: an app authentication module configured to perform app authentication through a verification process for the app downloaded to the mobile terminal; an app storage unit configured to have an app installed therein, the app being authenticated as a reliable app by the app authentication module; and a security engine application programming interface (API) called when the reliable app is executed, and configured to calculate an app ID of the calling reliable app and transmit the app ID to the security engine to request permission to access the security engine.

The security engine may include: an access control policy database (DB) configured to store the user authentication information and the app ID of the reliable app; and an access control module configured to receive the app ID and the user authentication information transmitted from the basic operating system, compare the received app ID and user authentication information with an app ID and user authentication stored in the access control policy DB, and authenticate whether an access app is the reliable app and whether an user executing the app is an owner of the mobile terminal.

The app ID stored in the access control policy DB may be transmitted and stored to the security engine after the security engine API calculates an app ID for an app authenticated as the reliable app by the app authentication module.

The security engine API may calculate an app ID only in response to call in the basic operating system.

In still another general aspect, a method of controlling access to a security engine of a mobile terminal, the method includes: calling a security engine API according to execution of an app installed in the mobile terminal; calculating, by the security engine API, an app ID of the calling app and transmitting the calculated app ID to an access control module of the security engine to request permission to access the security engine; determining, by the access control module, whether an app intended to access the security engine is a reliable app using the app ID transmitted from the security engine API; when the app intended to access the security engine is the reliable app, requesting user authentication information; checking whether a user executing the app is an owner of the mobile terminal base on user authentication information inputted by the user; and when the user executing the app is the owner of the mobile terminal, permitting access to the security engine.

The permitting of access to the security engine may include: keeping a channel communication between the security engine API and the security engine in an authenticated state after permitting access to the security engine, and ending and deactivating the channel communication when the app is ended.

In the requesting of permission to access the security engine, the calculation of the app ID may be performed based on app information managed by an operating system.

The determining of whether the app is the reliable app may include determining whether the app ID transmitted from the security engine API is registered with the access control policy DB of the security engine.

The determining of whether the app is the reliable app may include denying access to the security engine when the app is not determined as the reliable app.

The checking of whether a user is an owner of the mobile terminal may include determining whether user authentication information inputted by the user is previously set up in the access control policy DB of the security engine.

Other features and aspects will be apparent from the following detailed description, the drawings, and the claims.

### BRIEF DESCRIPTION OF THE DRAWINGS

FIG. 1 is a block diagram showing a system for controlling access to a security engine isolated in a mobile terminal.

FIG. 2 is a flowchart illustrating a method for installing and registering a reliable app.

FIG. 3 is a flowchart illustrating a method of controlling access to a security engine when an app is operated.

### DETAILED DESCRIPTION OF EMBODIMENTS

Advantages and features of the present invention, and implementation methods thereof will be clarified through following embodiments described with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. The terminology used herein is for the purpose of describing particular embodiments only and is not intended to be limiting of example embodiments. As used herein, the singular forms “a,” “an” and “the” are intended to include the plural forms as well, unless the context clearly indicates otherwise.

Hereinafter, embodiments of the present invention will be described in detail with reference to the accompanying drawings. In adding reference numerals for elements in each figure, it should be noted that like reference numerals already used to denote like elements in other figures are used for elements wherever possible. Moreover, detailed descriptions related to well-known functions or configurations will be ruled out in order not to unnecessarily obscure subject matters of the present invention.

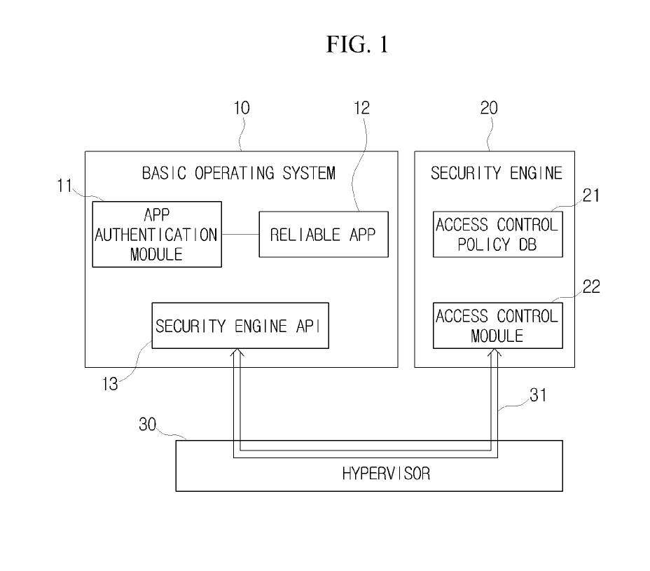

FIG. 1 is a block diagram showing a system for controlling access to a security engine isolated in a mobile terminal according to an embodiment of the present invention.

Referring to FIG. 1, the mobile terminal has a dual structure in which the basic operating system 10 and the security engine 20 are isolated from each other, and the basic operating system 10 and the security engine 20 are physically isolated by a hypervisor 30.

For example, the basic operating system 10 is an Android operating system, which is basically provided in a mobile terminal, and the security engine 20 provides a security function.

The basic operating system 10 includes an app authentication module 11, an app storage unit 12, and a security engine application programming interface (API) 13 in order to use the isolated security engine 20.

The app authentication module 11 may be included in an module for installing an app in a basic operating system or provided as a separate module, and configured to check whether an app installed through an authentication process with an app store, which distributes an app to be installed, is a normal app before installing an app in the mobile terminal.

After completing the authentication process, the app is installed as a reliable app in the mobile terminal, stored in the app storage unit 12, and registered as the reliable app with access control policy DB 21 via the access control module 22 through the security engine API 13.

The app failed in the authentication process is installed as a general app in a mobile terminal to prevent the isolated security engine from being used.

The security engine API 13 is an interface provided such that an app operated in the basic operating system may use a security function of the security engine 20.

When the app executed in the basic operating system requests a service from the security engine 20 through the security engine API 13, there is a communication channel 31 for delivering a service request to the hyperviser 30 in order to deliver the service request.

The security engine 20 has the access control module 22 configured to check an app that has requested the service and an user thereof to permit or deny the request of the security function service.

When the requested service is allowed or disallowed, the access control module 22 performs the check from the access control policy DB 21 for storing the reliable app and the user authentication information.

The access control policy DB 21 has information about the reliable app (app ID), and authentication information previously inputted by a user, for example, personal identity number (PIN) information, which are stored in order to check the subject of the service requested by the basic operating system 10. The information is used to check a subject that has requested a service when a service is requested through the security engine API 13.

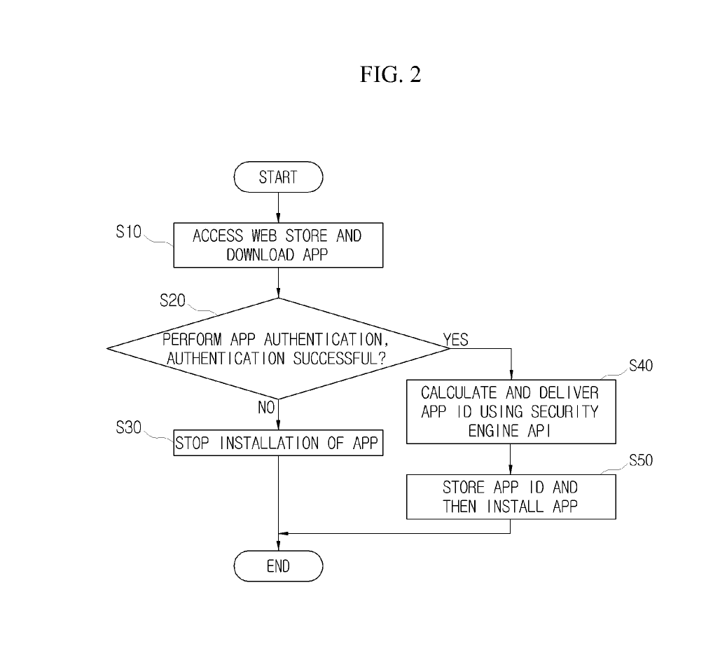

FIG. 2 is a flowchart showing for installing and registering a reliable app.

Referring to FIG. 2, a mobile user accesses an app store through a mobile terminal to download an app needed for a service in step S10.

In this case, the app store is separately operated and provided to safely distribute an app that is used for an enterprise or a specific institution to provide its own unique service (for example, an enterprise dedicated mail, a payment service, and so on).

In addition, the app download may be made by downloading an app selected by a user using an app installation module of the mobile terminal.

Next, the app authentication module 11 performs app authentication by verifying whether the downloaded app is distributed through a normal route or from a normal app store and whether the downloaded app is falsified such as inclusion of malicious codes in step S20.

In the app authentication module 11, the verification of whether the downloaded app is distributed through a normal route is mainly made through an electronic signature using a certificate, and the verification of whether the downloaded app is falsified through integrity information authentication for the app file.

If the authentication is failed (No in step S20), the app authentication module 11 determines that it is possible that the app is distributed through the abnormal route or falsified and stops installation of the app in step S30. In this case, the app failed in the authentication may be installed, as a general app, not to use the security engine.

If the authentication is successful (Yes in step S20), the security engine API 13 calculates an app ID for an app to be installed, and delivers the calculated app ID to the security engine 20 in step S40. Here, the app ID denotes a unique value for identifying the app. The app ID is safely calculated using a one-direction hash algorithm such that the different apps do not have the same value and cannot be estimated.

The app ID delivered to the security engine 20 is stored in the access control policy DB 21 and used when the app is installed and operated to use the security engine 20.

After storing the app ID in the access control policy DB 21, the security engine 20 normally installs the downloaded app in step S50, and the installed app is stored in the app storage unit 12.

The process of installing and registering the reliable app may be applied when accessing a specific app store to install the reliable app. For an app generally used, an open app store is accessed to install a required app. In this case, when the app authentication may be difficult, it is preferred to stop installation of the app or perform installation as a general app such that the isolated security engine cannot be accessed.

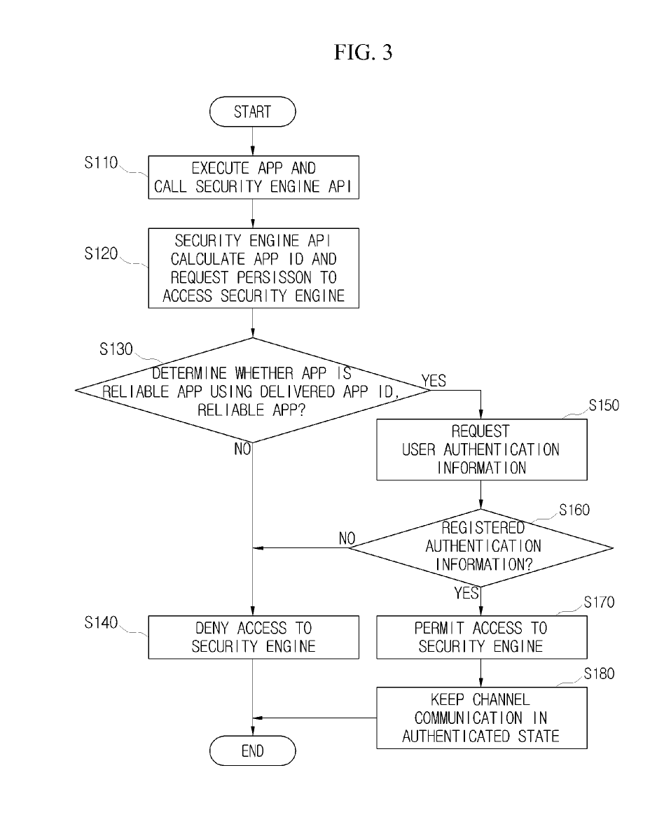

FIG. 3 is a flowchart showing a method of controlling access to a security engine when an app is operated.

Referring to FIG. 3, when an app installed in the mobile terminal is executed, the security engine API 13 is called in step S110. In this case, the app is a reliable app installed in the mobile terminal through the installation and registration process as shown in FIG. 2.

Next, the security engine API 13 calculates an app ID of the called app, transmits the calculated app ID to the access control module 22, and requests permission to access the security engine 20 in step S120. In this case, the security engine API 13 does not receive separate app information in an application level (user level), and calculates an app ID based on the app information (process information) that is managed in a system level (operations system level).

If the information about an executed app is received and calculated in a user application level (user level), the executed app information is generally received, but an app ID may be stolen by inputting reliable-app information registered with the access control policy DB 21 for a malicious purpose. When the app ID is calculated in the above-described method, the app ID may be prevented from being stolen.

In addition, in order to prevent an app developer having a malicious intention from arbitrarily storing or deleting the specific app information in or from the access control policy DB 21, it is preferred that the security engine API 13 is not opened and configured to calculate the app ID only through the call in the basic operating system 10.

The access control module 22 determines whether an app intended to access the security engine is a reliable app using the transmitted app ID. In this case, the access control module 22 determines whether the app is the reliable app, by searching for the app ID registered with the access control policy DB 21 to determine registration or not in step S130.

If the transmitted app ID is an app ID that is not registered with the access control policy DB 21, the access control module 22 determines that the app is not the reliable app (No in step S130) to deny access to the security engine in step S140.

If the transmitted app ID is an app ID that is registered with the access control policy DB 21, the access control module 22 determines that the app is the reliable app (Yes in step S130) to request user authentication information from the access control module in step S150. In this case, the access control module 22 may request input of a personal identification number (PIN), and authenticate whether a user executing an app is an owner of the mobile terminal based on this.

When the PIN input is requested from the access control module 22 and the PIN information is input, on the basis of the PIN information, the access control module 22 determines whether the input PIN information is matched with the PIN information that is previously set up in the access control policy DB 21 in step S150.

In this case, if the input PIN information is not matched with the PIN information registered in advance with the access control policy DB 21 (No in step S160), the access control module 22 determines that a user executing an app is not an owner of the mobile terminal to deny access to the security engine in step S140.

If the input PIN information is matched with the registered PIN information (Yes in step S160), the access control module 22 determines that a user executing an app is an owner of the mobile terminal to permit access to the security engine in step S170.

If the access to the security engine is permitted in step S170, the access control module 22 keeps a channel communication 31 of a hypervisor 30 that delivers a message to a security engine API in an authenticated state, in order to use a function of the security engine without the authentication process which is repeated while executing an app in step S180.

Subsequently, when the app is ended, the channel communication 31 of the authenticated hypervisor 30 is allowed to be ended and deactivated simultaneously with the end of the app.

As such, according to an embodiment of the present invention, in a mobile terminal structure having a security engine isolated from a basic operating system directly provided in the mobile terminal, it is possible to enhance security of the mobile terminal having the security engine by performing two-factor authentication based on authentication of a reliable app and an owner of the mobile terminal when there is an access from the basic operating system to the security engine.

Accordingly, it is also possible to enhance stability of financial transaction such as Internet banking and stock trading by increasing reliability of an app that is operated in the mobile terminal through the enhancement of security in the mobile terminal and to invigorate a smart work service for an enterprise or public institution, which has not been invigorated due to a security problem of the mobile terminal. That is, the present invention may be used to invigorate various services based on the mobile terminal that needs reliability of the terminal.

The system and method for registering an app ID of a mobile terminal and the system and method for controlling access to the security engine of the mobile terminal according to an embodiment of the present invention. However, the present invention is not limited to the particularly preferred embodiments. It is apparent to one skilled in the art that there are many various modifications and variations without departing from the spirit or the technical scope of the appended claims.

Accordingly, the embodiments of the present invention are to be considered descriptive and not restrictive of the present invention, and do not limit the scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A system for registering an app ID of a mobile terminal, the system comprising:
a basic operating system perform app authentication through a verification process for a downloaded app and when the authentication is successful, calculate an app ID of the downloaded app and transmit the app ID to the security engine; and
a security engine configured to store the app ID calculated in the basic operating system.

2. The system of claim 1, wherein the basic operating system comprises:
an app authentication module configured to perform app authentication through a verification process for the downloaded app;
an app storage unit configured to have an app installed therein, the app being authenticated by the app authentication module; and
a security engine application programming interface (API) configured to calculate an app ID of the app authenticated by the app authentication module and transmits the app ID to the security engine.

3. The system of claim 1, wherein the security engine comprises:
an access control policy database (DB) configured to store an app ID of a reliable app; and
an access control module configured to receive the app ID transmitted from the basic operating system and store the app ID in the access control policy DB.

4. The system of claim 1, wherein the basic operating system verifies whether the downloaded app is distributed through a normal route or from a normal app store or whether the downloaded app is falsified to perform the app authentication.

5. The system of claim 4, wherein the verification of whether the downloaded app is distributed from the normal app store and the verification of whether the downloaded app is falsified is achieved through an electronic signature using a certificate or through integrity information authentication for the app file.

6. The system of claim 2, wherein when the app authentication is failed in the app authentication module, the installation of the downloaded app is stopped or the downloaded app is stored as a general app in the app storage.

7. The system of claim 2, wherein the calculation of the app ID by the security engine API is performed using a one-direction hash algorithm.

8. A system for controlling access to a security engine of a mobile terminal, the system comprising:
a basic operating system configured to execute a reliable app installed therein to transmit an app ID and user authentication information to the security engine in order to use a security function of the security engine; and
a security engine configured to authenticate whether an app is the reliable app or whether a user executing the reliable app is an owner of the mobile terminal based on the app ID transmitted and the user authentication information from the basic operating system and then permit access to the security engine.

9. The system of claim 8, wherein the basic operating system comprises:
an app authentication module configured to perform app authentication through a verification process for the app downloaded to the mobile terminal;
an app storage unit configured to have an app installed therein, the app being authenticated as a reliable app by the app authentication module; and
a security engine application programming interface (API) called when the reliable app is executed, and configured to calculate an app ID of the calling reliable app and transmit the app ID to the security engine to request permission to access the security engine.

10. The system of claim 9, wherein the security engine comprises:
an access control policy database (DB) configured to store the user authentication information and the app ID of the reliable app; and
an access control module configured to receive the app ID and the user authentication information transmitted from the basic operating system, compare the received app ID and user authentication information with an app ID and user authentication stored in the access control policy DB, and authenticate whether an access app is the reliable app and whether an user executing the app is an owner of the mobile terminal.

11. The system of claim 10, wherein the app ID stored in the access control policy DB is transmitted and stored to the security engine after the security engine API calculates an app ID for an app authenticated as the reliable app by the app authentication module.

12. The system of claim 9, wherein the security engine API calculates an app ID only in response to call in the basic operating system.

13. A method of controlling access to a security engine of a mobile terminal, the method comprising:
calling a security engine API according to execution of an app installed in the mobile terminal;
calculating, by the security engine API, an app ID of the calling app and transmitting the calculated app ID to an access control module of the security engine to request permission to access the security engine;
determining, by the access control module, whether an app intended to access the security engine is a reliable app using the app ID transmitted from the security engine API;
when the app intended to access the security engine is the reliable app, requesting user authentication information;
checking whether a user executing the app is an owner of the mobile terminal base on user authentication information inputted by the user; and
when the user executing the app is the owner of the mobile terminal, permitting access to the security engine.

14. The method of claim 13, wherein the permitting of access to the security engine comprises keeping a channel communication between the security engine API and the security engine in an authenticated state after permitting access to the security engine and ending and deactivating the channel communication when the app is ended.

15. The method of claim 13, wherein in the requesting of permission to access the security engine, the calculation of the app ID is performed based on app information managed by an operating system.

16. The method of claim 13, wherein the determining of whether the app is the reliable app comprises determining whether the app ID transmitted from the security engine API is registered with the access control policy DB of the security engine.

17. The method of claim 13, wherein the determining of whether the app is the reliable app comprises denying access to the security engine when the app is not determined as the reliable app.

18. The method of claim 13, wherein the checking of whether a user is an owner of the mobile terminal comprises determining whether user authentication information inputted by the user is previously set up in the access control policy DB of the security engine.
